(19) United States
(12) Patent Application Publication
(10) Pub. No.: US 2006/0285823 A1
(43) Pub. Date: Dec. 21, 2006

(54) Method for executing scheduled record task

(75) Inventor: Lu-Kang Mao, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/435,252

(22) Filed: May 16, 2006

(30) Foreign Application Priority Data
Jun. 17, 2005 (TW) 094120272

(51) Int. Cl. H04N 5/91

(52) U.S. Cl. 386/83

(57) ABSTRACT

In a scheduled recording method, a specific recording apparatus perform a checking procedure in response to a triggering signal to upon actuating a scheduled record task for the specific recording apparatus, thereby realizing whether the specific recording apparatus is able to implement the scheduled record task. Then, a request command is issued from the specific recording apparatus to the network system in the situation when the specific recording apparatus fails to implement the scheduled record task. The remaining recording apparatuses which is linked to the network system performs the identical checking procedures in response to the request command, and responds a relay signal when one of the remaining recording apparatuses is able to implement the scheduled record task. Afterward, the one of the remaining recording apparatuses implements the scheduled record task in response to the relay signal.

### FIELD OF THE INVENTION

The present invention relates to a method for executing a scheduled record task, and more particularly to a method for scheduled recording a television program by issuing a request command into a network system.

### BACKGROUND OF THE INVENTION

Conventionally, a video cassette recorder (VCR) was widely used to record television programs. By means of the VCR, a viewer is able to record a visual program by presetting program times into the VCR while viewing a different channel. The VCR concept has been expanded in recent years to include digital compression devices that provide additional features for recording analog visual programs. Since the general trends in recording data are toward high memory capacity, versatility and high video quality, the VCR recording technology is not satisfied.

Nowadays, a digital recording/reproducing apparatus, for example a DVD recorder, is used to record video data into a recordable disc or reproduce video data from a readable disc. The digital recording/reproducing apparatus can be used with various kinds of electrical appliances to record video data from various sources such as a TV tuner, a video cassette recorder (VCR), a DVD player or a digital video (DV) camera.

The storage medium used in the digital recording/reproducing apparatus includes a write once compact disc (CD-R), a write once digital versatile disc (DVD-R), a rewritable compact disc (CD-RW), a rewritable digital versatile disc (DVD-RW), etc. In a case that the digital recording/reproducing apparatus has a hard disc drive and a burner therein, the data received from the TV tuner, the VCR, the DVD player or the DV camera are firstly converted into digital data and then stored in the hard disc drive in an editable manner. Alternatively, by using the disc burner, the edited digital data are recorded into a recordable disc. The digital recording/reproducing apparatus exhibits functions of record and playback and generally has other extended uses, for example scheduled record.

Generally, a DVD player is becoming a main stream in the digitalized industry because the DVD disc has high memory capacity and is compatible to play any CD disc. The current DVD disc comprises two 0.6 mm substrates bonded together. Data can be recorded into either or both substrates. The simplest DVD disc has a capacity of 4.7 GB because a single layer of only one of the two substrates contains data. A dual-layer/single-side version has a capacity of 8.5 GB which is slightly less than twice the single layer version because two single layers of one of the two substrates contains data. A double-side/single-layer version has a capacity of 9.4 GB, in which two sides of the disc contain data. In addition, a double-side/dual-layer version has the largest capacity of 17 GB in the DVD disc family because each of the two sides has dual layers for recording data therein. For a purpose of achieving high digital compression quality, the digital data are preferable recorded in the MPEG-2 (Motion Picture Expert Group 2) format and in the storage memory device having high memory capacity. Generally, the 17-GB DVD disc or the built-in hard disc drive is feasible for recording digital data. The overall time period for scheduled record depends on the memory capacity of the storage medium device. For example, if the 17-GB DVD disc is used to record a program, the presetting program time is approximately 8 hours.

Whenever the DVD disc or the hard disc drive is employed for scheduled record, the memory capacity is limited. That is to say, if the users are intended to record a certain television program played in a certain time of a day for a week or month, they should periodically change DVD disc or refresh contents in the hard disc drive. Otherwise, the recording result is incomplete. In addition, the scheduled record function will be interrupted or terminated by other persons setting the digital recording/reproducing apparatus to perform a playback function or another record functions before/when the scheduled record function is executed.

### SUMMARY OF THE INVENTION

The present invention provides a method for executing a scheduled record task to effectively record a certain program played at a certain channel and in a certain time, thereby avoiding incomplete recording results.

The present invention relates to a method for executing a scheduled record task for use between plural recording apparatuses linked to a network system. In the scheduled recording method, a specific recording apparatus perform a checking procedure in response to a triggering signal to upon actuating a scheduled record task for the specific recording apparatus, thereby realizing whether the specific recording apparatus is able to implement the scheduled record task. The scheduled record task includes a step of receiving external video signals of a television program played at a certain channel and in a certain preset starting time. The scheduled record task includes a step of receiving external video signals of a television program played at a certain channel and in a certain preset starting time, and a step of converting the external video signals into digital data. Then, a request command is issued from the specific recording apparatus to the network system in the situation when the specific recording apparatus fails to implement the scheduled record task. The remaining recording apparatuses which is linked to the network system performs the identical checking procedures in response to the request command, and responds a relay signal when one of the remaining recording apparatuses is able to implement the scheduled record task. Afterward, the one of the remaining recording apparatuses implements the scheduled record task in response to the relay signal. The method of the present invention further comprises a step of issues an implementation signal from the one of the remaining recording apparatuses to the network system to inform the specific recording apparatus of completion of the scheduled record task.

In an embodiment, the network system is a local network system having a hub linked to corresponding network interfaces of the plural recording apparatuses.

In an embodiment, the plural recording apparatuses comprise at least two DVD recorders having individual channel selective interfaces therein. In another embodiment, the plural recording apparatuses comprise at least one DVD recorder and at least one personal computer personal computer having individual channel selective interfaces therein.

In an embodiment, the checking procedures are performed to realize whether the available resources of the specific and the remaining recording apparatuses are sufficient. In one case, each of the specific and the remaining recording apparatuses includes a built-in hard disc drive, and the available resource includes the available recordable space of the hard disc. In another case, each of the specific and the remaining recording apparatuses includes a disc burner, and the available resource includes the available recordable space of a recordable disc loaded in the disc burner.

In an embodiment, the checking procedures are performed to realize whether the specific and the remaining recording apparatuses are executing the tasks other than the scheduled record task.

In an embodiment, another request command is issued from the one of the remaining recording apparatuses to the network system when the scheduled record task is interrupted. The method further comprises steps of issuing a download signal from the specific recording apparatus to the one of the remaining recording apparatuses; and transmitting the information associated with the scheduled record task to the specific recording apparatus in response to the download signal, so that the information associated with the scheduled record task is directly played by the specific recording apparatus or recorded in the specific recording apparatus.

The present invention also relates to a method for executing a scheduled record task for use between plural recording apparatuses linked to a network system. In the scheduled recording method, a specific recording apparatus executes the scheduled record task of receiving and recording external video signals of a television program played at a certain channel and in a certain preset starting time. Then, a request command is issued from the specific recording apparatus to the network system in the situation when the scheduled record task is interrupted. The remaining recording apparatuses which is linked to the network system performs checking procedures in response to the request command, and responding a relay signal when one of the remaining recording apparatuses is able to implement the scheduled record task. Afterward, the one of the remaining recording apparatuses which is linked to the network system implements the scheduled record task.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram of a network system for executing scheduled record according to a preferred embodiment of the present invention;

FIG. 2(a) is a functional block diagram illustrating the configuration of the recording/reproducing apparatus used in the network system shown in FIG. 1;

FIG. 2(b) is a functional block diagram illustrating the configuration of the computer system used in the network system shown in FIG. 1;

FIG. 3 is a flowchart illustrating a scheduled recording method according to an embodiment of the present invention; and

FIG. 4 is a flowchart illustrating a scheduled recording method according to another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

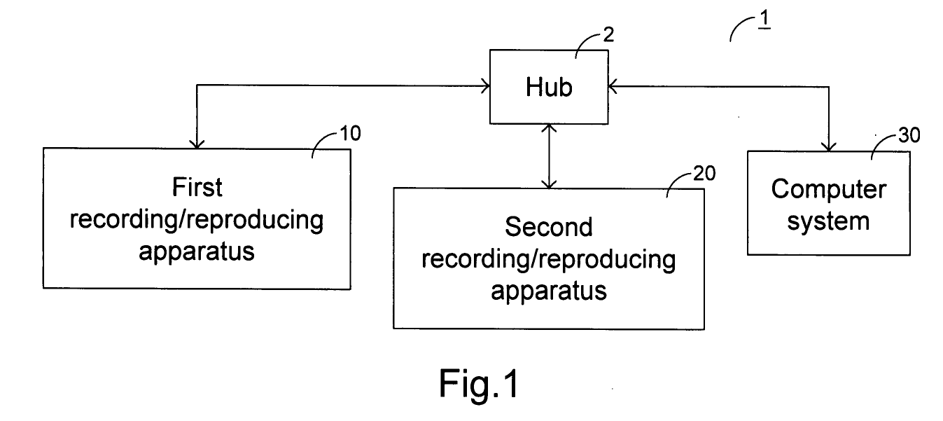

Referring to FIG. 1, a functional block diagram of a network system for executing scheduled record according to a preferred embodiment of the present invention is shown. The network system 1, for example a local network system, comprises a first recording/reproducing apparatus 10, a second recording/reproducing apparatus 20 and a computer system 30. Via a hub 2, the first recording/reproducing apparatus 10, the second recording/reproducing apparatus 20 and the computer system 30 are communicable with each other.

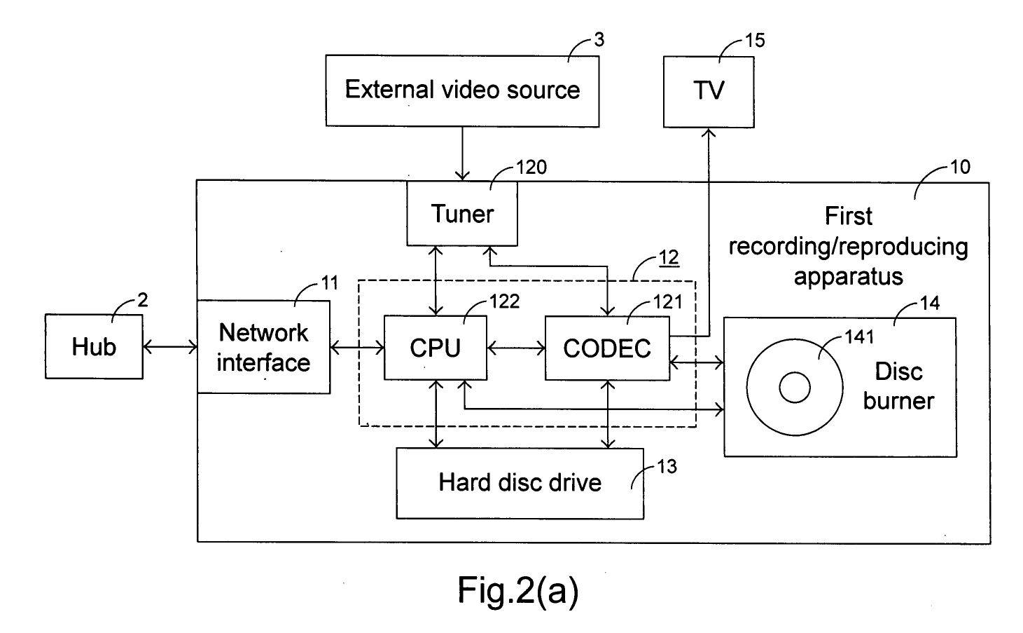

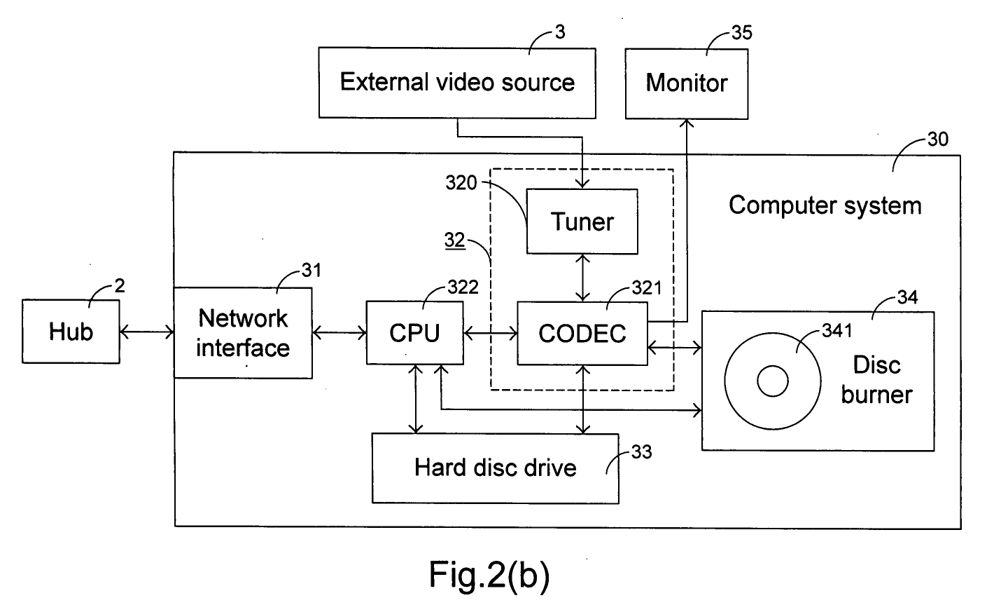

Please refer to FIG. 2(a), which is a functional block diagram illustrating the configuration of the recording/reproducing apparatus 10 used in the network system. The recording/reproducing apparatus 10, for example a DVD recorder, includes a network interface 11, a control circuit 12, a digital data storage device such as a hard disc drive 13 and a disc burner 14. Via the network interface 11, the recording/reproducing apparatus 10 communicates with the second recording/reproducing apparatus 20 and the computer system 30, which are linked to the hub 2. The control circuit 12 comprises a video coder-decoder (CODEC) 121 and a central processing unit (CPU) 122, both of which are electrically connected to a tuner 120. The tuner 120 is communicated with an external video source 3 such as a cable television or a wireless television so as to receive the external video signals. The tuner 120 serves as a channel selective interface capable of periodically receiving and analyzing the video signals from the external video source 3. The video signals received from the TV tuner 120 are transmitted to the video coder-decoder 121 of the control circuit 12 to be converted into digital video data in a specified format such as MPEG. The MPEG digital video data are then stored in the hard disc drive 13 in an editable manner. The edited digital video data can be recorded into a recordable disc 141 by using the disc burner 14. On the other hand, it is also possible to directly playback the MPEG digital video data on a television 15. An example of the recordable disc 141 includes a write once compact disc (CD-R), a write once digital versatile disc (DVD-R), a rewritable compact disc (CD-RW) or a rewritable digital versatile disc (DVD-RW).

The configuration of the recording/reproducing apparatus 20 is similar to that of the recording/reproducing apparatus 10, and will not be described redundantly herein.

Referring to FIG. 2(b), a functional block diagram of the computer system 30 used in the network system is illustrated. The computer system 30, for example a personal computer, includes a network interface 31, a graphics card 32 including a tuner 320 and a video coder-decoder (CODEC) 321, a central processing unit (CPU) 322, a digital data storage device such as a hard disc drive 33 and a disc burner 34. Via the network interface 31, the computer system 30 communicates with the first and second recording/reproducing apparatuses 10 and 30 linked to the hub 2. The tuner 320 is communicated with the external video source 3 so as to receive the external video signals. The tuner 320 also serves as a channel selective interface capable of periodically receiving and analyzing the video signals from the external video source 3. The video signals received from the tuner 320 are transmitted to the video coder-decoder 321 of the graphics card 32 to be converted into digital video data in a specified format such as MPEG. The MPEG digital video data are then stored in the hard disc drive 33 in an editable manner. The edited digital video data can be recorded into a recordable disc 341 by using the disc burner 34. On the other hand, it is also possible to directly playback the MPEG digital video data on a monitor 35.

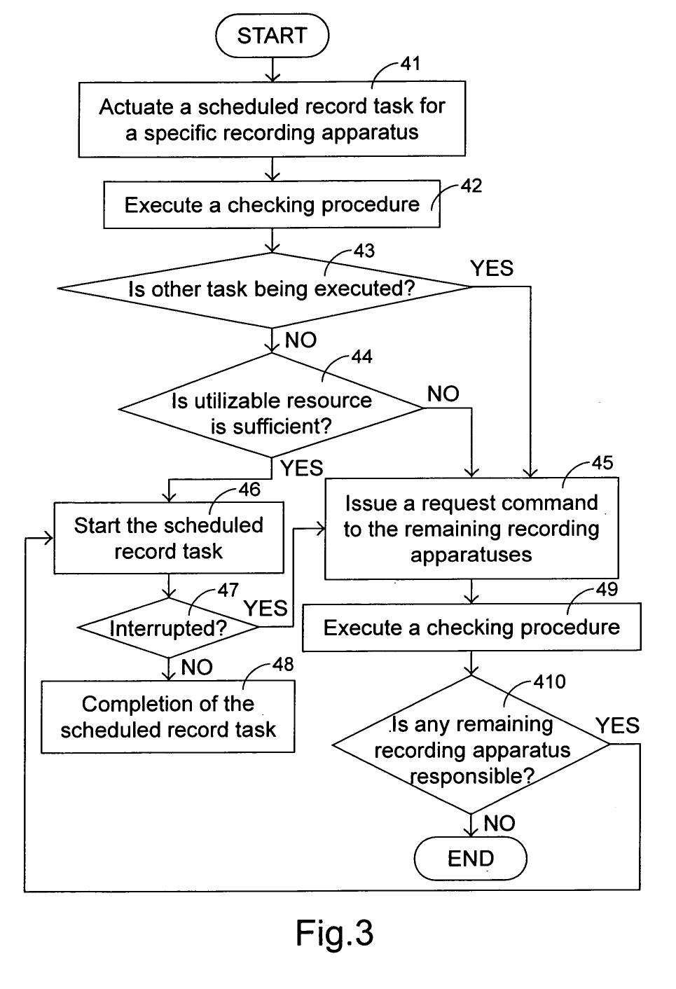

The network system 1 of the present invention allows users to instruct the DVD recorder to automatically record specific upcoming television programs. The instructions typically designate a channel, a start time, an end time, a recording period, a video source and the recording quality. Hereinafter, an embodiment for executing a scheduled record task according to the network system 1 of the present invention will be illustrated with reference to FIG. 3.

In response to a triggering signal upon actuating a scheduled record task for the recording/reproducing apparatus 10 (Step 41), a checking procedure is executed to realize whether the available resource of the recording/reproducing apparatus 10 is sufficient or whether the recording/reproducing apparatus 10 is not executing other tasks such as playback (Step 42). For example, the available resource includes the available recordable space of hard disc drive 13 or the recordable disc 141 loaded in the disc burner 14. If the recording/reproducing apparatus 10 is executing other task (Step 43) or the utilizable resource checked by the central processing unit 122 is insufficient (Step 44), a request command is issued from the recording/reproducing apparatus 10 to the recording/reproducing apparatus 20 and the computer system via the hub 2 (Step 45). Otherwise, the recording/reproducing apparatus 10 will start the scheduled record task until the preset time is due (Step 46). Alternatively, if scheduled record task is interrupted by other persons (Step 47), the recording/reproducing apparatus 10 also issues a request command to the recording/reproducing apparatus 20 and the computer system via the hub 2 (Step 45). Otherwise, the scheduled record task is continued until completion (Step 48). In response to the request command, the similar checking procedure is executed to realize whether the available resource of the recording/reproducing apparatus 20 or the computer system 30 is sufficient or whether the recording/reproducing apparatus 20 or the computer system 30 is not executing other tasks (Step 49). If the recording/reproducing apparatus 20 or the computer system 30 is able to implement the scheduled record task, i.e. the available resource of is sufficient and no other tasks are being executed (Step 410), the recording/reproducing apparatus 20 or the computer system 30 is responsible for the scheduled record task. Under this circumstance, the responsible recording apparatus will start the scheduled record task (Step 46), and the Steps 46˜410 will be optionally selected to execute. Optionally, when the scheduled record task is completed, the responsible recording apparatus may issue an implementation signal to inform the recording/reproducing apparatus 10 of completion of the scheduled record task.

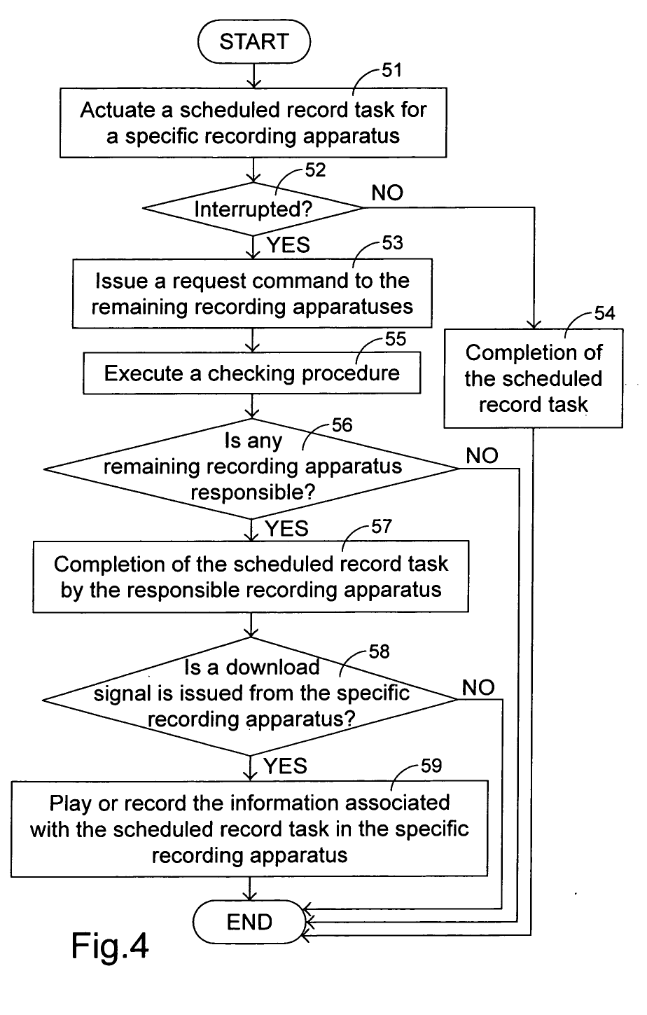

A further embodiment for executing a scheduled record task is illustrated with reference to FIG. 4.

First of all, in response to a triggering signal, a scheduled record task is actuated for the recording/reproducing apparatus 10 to record external video signals of a television program played at a certain channel and in a certain preset starting time (Step 51). If the scheduled record task is interrupted (Step 52), a request command is issued from the recording/reproducing apparatus 10 to the recording/reproducing apparatus 20 and the computer system via the hub 2 (Step 53). Otherwise, the scheduled record task is continued until completion (Step 54). In response to the request command, a checking procedure similar to that described in the above embodiment is executed to realize whether the available resource of the recording/reproducing apparatus 20 or the computer system 30 is sufficient or whether the recording/reproducing apparatus 20 or the computer system 30 is not executing other tasks (Step 55). If the recording/reproducing apparatus 20 or the computer system 30 is able to implement the scheduled record task, (Step 56), the responsible recording apparatus 10 or 20 will respond a relay signal and then start the scheduled record task (Step 57). Optionally, when the scheduled record task is completed, the responsible recording apparatus may issue an implementation signal to inform the recording/reproducing apparatus 10 of completion of the scheduled record task. Subsequently, in response to a download signal issued from the recording/reproducing apparatus 10 (Step 58), the information associated with the scheduled record task is transmitted to the recording/reproducing apparatus 10 in order to be directly played or recorded in recording/reproducing apparatus 10 (Step 59).

From the above description, by providing the network system and the scheduled recording method of the present invention, the problem of causing incomplete recording result can be effectively solved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for executing a scheduled record task for use between plural recording apparatuses linked to a network system, comprising steps of:
allowing a specific recording apparatus to perform a checking procedure in response to a triggering signal to upon actuating a scheduled record task for the specific recording apparatus, thereby realizing whether the specific recording apparatus is able to implement the scheduled record task;
issuing a request command from the specific recording apparatus to the network system in the situation when the specific recording apparatus fails to implement the scheduled record task;
allowing the remaining recording apparatuses linked to the network system to perform the identical checking procedures in response to the request command, and responding a relay signal when one of the remaining recording apparatuses is able to implement the scheduled record task; and
allowing the one of the remaining recording apparatuses to implement the scheduled record task in response to the relay signal.

2. The method according to claim 1 wherein the network system is a local network system having a hub linked to corresponding network interfaces of the plural recording apparatuses.

3. The method according to claim 1 wherein the plural recording apparatuses comprise at least two DVD recorders having individual channel selective interfaces therein.

4. The method according to claim 1 wherein the plural recording apparatuses comprise at least one DVD recorder and at least one personal computer personal computer having individual channel selective interfaces therein.

5. The method according to claim 1 wherein the checking procedures are performed to realize whether the available resources of the specific and the remaining recording apparatuses are sufficient.

6. The method according to claim 5 wherein each of the specific and the remaining recording apparatuses includes a built-in hard disc drive, and the available resource includes the available recordable space of the hard disc.

7. The method according to claim 5 wherein each of the specific and the remaining recording apparatuses includes a disc burner, and the available resource includes the available recordable space of a recordable disc loaded in the disc burner.

8. The method according to claim 1 wherein the checking procedures are performed to realize whether the specific and the remaining recording apparatuses are executing the tasks other than the scheduled record task.

9. The method according to claim 1 further comprising a step of issues an implementation signal from the one of the remaining recording apparatuses to the network system to inform the specific recording apparatus of completion of the scheduled record task.

10. The method according to claim 1 wherein the scheduled record task includes a step of receiving external video signals of a television program played at a certain channel and in a certain preset starting time.

11. The method according to claim 10 wherein the scheduled record task includes a step of converting the external video signals into digital data.

12. The method according to claim 10 wherein another request command is issued from the one of the remaining recording apparatuses to the network system when the scheduled record task is interrupted.

13. The method according to claim 12 further comprising steps of:
issuing a download signal from the specific recording apparatus to the one of the remaining recording apparatuses; and
transmitting the information associated with the scheduled record task to the specific recording apparatus in response to the download signal, so that the information associated with the scheduled record task is directly played by the specific recording apparatus or recorded in the specific recording apparatus.

14. A method for executing a scheduled record task for use between plural recording apparatuses linked to a network system, comprising steps of:
allowing a specific recording apparatus to execute the scheduled record task of receiving and recording external video signals of a television program played at a certain channel and in a certain preset starting time;
issuing a request command from the specific recording apparatus to the network system in the situation when the scheduled record task is interrupted;
allowing the remaining recording apparatuses linked to the network system to perform checking procedures in response to the request command, and responding a relay signal when one of the remaining recording apparatuses is able to implement the scheduled record task; and
allowing the one of the remaining recording apparatuses linked to the network system to implement the scheduled record task.

15. The method according to claim 14 wherein the network system is a local network system having a hub linked to corresponding network interfaces of the plural recording apparatuses.

16. The method according to claim 14 wherein the plural recording apparatuses comprise at least two DVD recorders having individual channel selective interfaces therein or at least one DVD recorder and at least one personal computer personal computer having individual channel selective interfaces therein.

17. The method according to claim 14 further comprising a step of issues an implementation signal from the one of the remaining recording apparatuses to the network system to inform the specific recording apparatus of completion of the scheduled record task.

18. The method according to claim 14 wherein the checking procedures are performed to realize whether the available resources of the remaining recording apparatuses are sufficient.

19. The method according to claim 18 wherein each of the recording apparatuses includes a built-in hard disc drive and a burner, and the available resource includes the available recordable space of the hard disc and a recordable disc loaded in the disc burner.

20. The method according to claim 14 further comprising steps of:
issuing a download signal from the specific recording apparatus to the one of the remaining recording apparatuses; and
transmitting the information associated with the scheduled record task to the specific recording apparatus in response to the download signal, so that the information associated with the scheduled record task is directly played by the specific recording apparatus or recorded in the specific recording apparatus.
